(19) United States
(12) Patent Application Publication
(10) Pub. No.: US 2013/0249125 A1
(43) Pub. Date: Sep. 26, 2013

(54) VARIABLE CONCENTRATION DYNAMIC HEADSPACE VAPOR SOURCE GENERATOR

(71) Applicant: James J. McKinley, League City, TX (US)

(72) Inventor: James J. McKinley, League City, TX (US)

(21) Appl. No.: 12/734,637

(22) PCT Filed: Nov. 13, 2008
(86) PCT No.: PCT/US2008/012727

§ 371 Date: Jun. 1, 2011

Related U.S. Application Data
(60) Provisional application No. 61/002,969, filed on Nov. 13, 2007.

(51) Int. Cl. G01N 1/28

(52) U.S. Cl. CPC G01N 1/28
USPC 261/130

(57) ABSTRACT

A vapor source generator comprising: a vapor pressure chamber within which carrier gas flows over a vapor source; means to regulate chamber temperature; and means to regulate chamber pressure.

### BACKGROUND

The invention relates generally to saturation of a vapor, and more particularly to introducing a vapor from a solid or liquid source into a flowing gas stream in defined proportions as a small regulated flow of carrier gas is passed over the source where it mixes with the vapor at the surface of the source, thereby creating a test atmosphere of known amounts of the source.

Bubblers have been frequently used for saturating a gas. Flow regulating devices (FR), flow measurement and control devices (FC), and pressure measurement devices (PI), back-pressure regulators and associated connection tubing are also known in the art.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION

The invention provides for saturation of a vapor by some means to create a test atmosphere. This invention improves on the way that the gas is saturated with vapor.

### DRAWINGS

These and other features, aspects, and advantages of the present invention will become better understood when the following detailed description is read with reference to the accompanying drawings in which like characters represent like parts throughout the drawings, wherein:

FIG. 1 shows a diagram view of an exemplary embodiment of the present invention comprising a vapor pressure chamber;

FIG. 2 shows a diagram view of an exemplary embodiment of the present invention comprising a vapor pressure chamber; and

FIG. 3 shows a diagram view of an exemplary embodiment of the present invention comprising a vapor pressure chamber.

### DETAILED DESCRIPTION

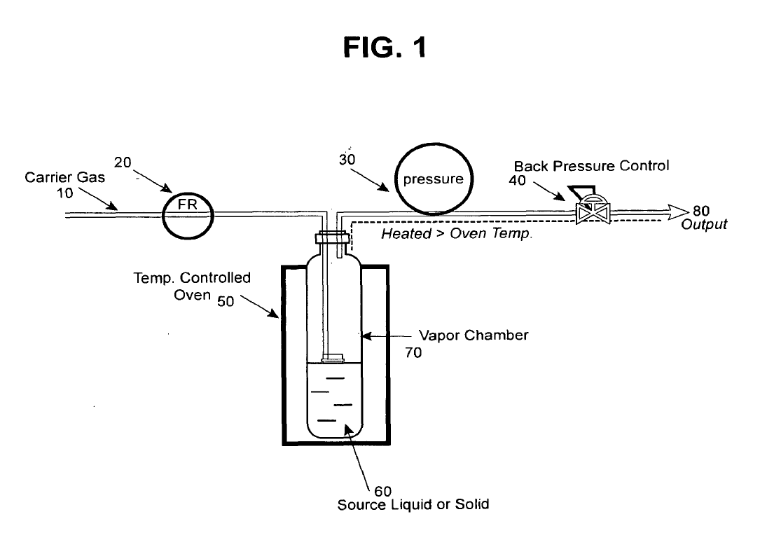

As shown in FIGS. 1, 2 and 3, embodiments of the present invention may comprise a temperature controlled vapor pressure chamber 70 wherein the carrier gas 10 flows over a source 60, and the chamber 70 is set to a known saturation pressure while being held at a constant temperature. Exemplary embodiments may further comprise a flow regulating device (FR) 20, a flow measurement and control device (FC), and pressure measurement device 30 (PI), back-pressure regulator 40 and associated connection tubing. The source 60 may be liquid or solid and carrier gas 10 may flow over a liquid source 60 instead of bubbling through it. carrier gas 10 may also flow through a porous solid. Pressure measurement can also be referred to as pressure indication. Flow regulation can also be called flow control. The pressure control device can also be referred to as a back pressure regulator 40 or pressure relief device.

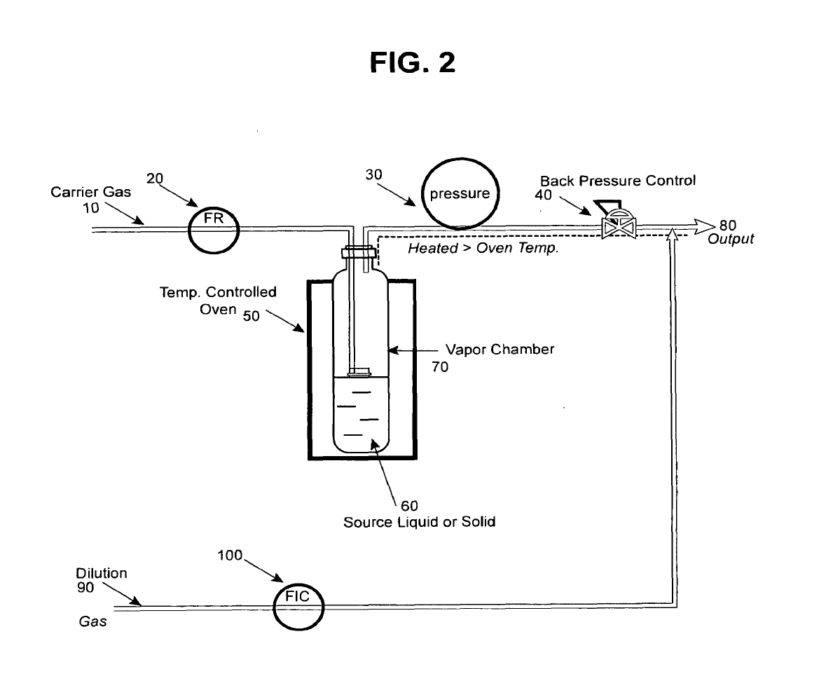

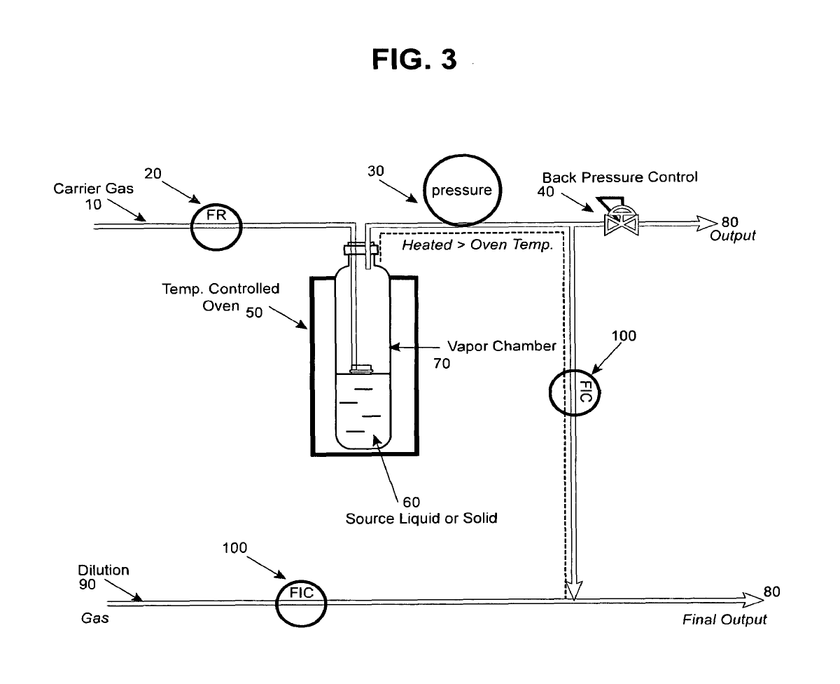

As can be seen in the embodiment shown in FIG. 3, a split flow controller can be added to the embodiments shown in FIGS. 1 and 2 in order to introduce a variable portion of the saturated carrier to dilution gas flow.

In the embodiment shown in FIG. 2, the total volume of gas can be increased by adding external unsaturated dilution gas. This simultaneously changes the concentrations in the output stream 80.

In the embodiment shown in FIG. 3, a variable portion of the saturated chamber mixture is added to an additional flow of dilution gas. This has the advantage of allowing variable levels of concentration while maintaining a fixed total output flow rate.

In the temperature controlled vapor pressure chamber 70 wherein the carrier gas 10 flows over the source 60, the chamber 70 is set to a known saturation pressure while being held at a constant temperature, and the carrier gas flow regulating device 20 maintains a constant flow with varying saturation pressure.

In another embodiment of the present invention, the addition of a split flow controller allows the introduction of a variable portion of the saturated carrier to dilution gas flow.

The pressure of the carrier gas 10 introduced to the flow regulating device 20 (FR) should be above the output pressure by an amount sufficient to properly control carrier and dilution gas flow rates.

The carrier gas flow regulator 20 can maintain a constant flow rate at varying saturation pressures.

The transport lines carrying the vapor mixture downstream of the vapor chamber 70 can be heated to match or exceed the oven 50 temperature so as to minimize condensation.

Since the carrier gas 10 flows over the surface of liquid sources 60 and is not bubbled through, a more stable output concentration is generated. Bubble-through devices can cause uncontrolled concentration spikes in the generated test atmosphere due to entrainment of liquid droplets within the gas stream.

Embodiments of the present invention can be used for:
Creating a known test atmosphere of common atmospheric contaminants, for example diesel fuel and/or insect repellent, for testing the measurement response of a sensor in the presence of the interferrents.
Creating a known contaminant atmosphere and testing the deterioration of construction or other material, such as clothing, at differing amounts of contaminant.
Creating a known test atmosphere for testing the effectiveness of vapor corrosion inhibitors.
Interferrent testing of catalytic systems.
Creating a test atmosphere to be used as a dopant to promote or control some type of chemical reaction.
Creating a test atmosphere to simulate nature in some way (for example creating a test atmosphere from tree turpines), wherein the test atmosphere is then used in health effects or inhalation studies.
When the source 60 is liquid water, creating a known amount of humidity to be added to a downstream gas stream. It is possible to have a membrane that is extremely permeable to water to create a soaked surface. This methodology is useful for adding humidity to a gas stream when a membrane that is highly permeable to water is interposed between the liquid water and gas to be humidified. This allows a large surface for evaporation of the water while physically separating the gas from the liquid water. This method allows humidifying gases that are somewhat soluble in water and could be used for any combination of gas and source liquid 60 where a suitable membrane exists. For water, a suitable membrane material (Nafion®) is available.

Embodiments of the present invention can be used to train a dog in detection of explosives with a test atmosphere containing a background odor such as coffee bean vapor.

Embodiments of the present invention can be used to calibrate an electronic “nose” wherein the nose has been optimized in its measurement response to a test atmosphere containing known interferrents.

The carrier gas 10 can be a dry clean gas (preferred), but can also be a known multi-component gas for special studies, or for special cases in which the multi-component carrier gas 10 reacts with components of the liquid or solid source 60.

An embodiment of the present invention may provide for circulation or agitation of the source 60 to improve performance.

Adding means for adjusting temperature to an embodiment may add versatility in allowing the device to go to higher (or lower) source vapor pressures and in generating higher (or lower) concentrations.

In embodiments of the present invention, the source 60 must be a liquid or solid under operating temperature and pressure conditions and the source material 60 must produce a vapor.

The vapor chamber 70 must withstand the saturation pressure and must be constructed of material that is inert to the source 60 and the carrier gas 10.

The test atmosphere in the invention can be generated under adjustable saturation pressures. This provides variable saturation ratios while avoiding the dynamic cooling effects of varying vaporization rates.

Embodiments of the present invention allow saturation with a constant vaporization rate within the chamber 70. This reduces unknown variations in saturation rate due to the dynamic effects of vaporization.

Embodiments of the present invention allow generation of varying concentrations of test atmospheres by varying the dilution flow rate instead of varying the flow rate across the chamber 70. In this way, the temperature of the chamber 70 is not affected by differing concentrations within the chamber 70.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A vapor source generator comprising: a vapor pressure chamber within which carrier gas flows over a solid or liquid vapor source,
means to regulate vapor chamber temperature, and
means to maintain constant vapor chamber temperature.

2. The vapor source generator of claim 1 further comprising means for circulating or agitating said vapor source.

3. The vapor source generator of claim 2 further comprising a membrane positioned between said vapor source and said carrier gas wherein said membrane is permeable to said vapor source.

4. The vapor source generator of claim 1 further comprising means to regulate chamber pressure and maintain a known saturation pressure within said vapor chamber.

5. The vapor source generator of claim 1 further comprising a flow regulating device in fluid communication with said vapor pressure chamber.

6. The vapor source generator of claim 5 wherein said flow regulating device regulates carrier gas flow rate into said vapor pressure chamber.

7. The vapor source generator of claim 5 further comprising a flow measurement and control device that regulates the flow of dilution gas into output gas from said vapor pressure chamber.

8. The vapor source generator of claim 5 further comprising a pressure measurement device that measures the pressure of gas from said vapor pressure chamber.

9. The vapor source generator of claim 8 further comprising a back pressure regulator that regulates the pressure of output gas from said vapor pressure chamber.

10. The vapor source generator of claim 7 further comprising a split flow controller in fluid communication with said dilution gas flow and output gas from said vapor pressure chamber.

11. The vapor source generator of claim 10 wherein said split flow controller regulates flow of output gas from said vapor pressure chamber into said dilution gas flow.

12. The vapor source generator of claim 6 wherein said flow regulating device maintains constant carrier gas flow rate despite pressure changes.

13. The vapor source generator of claim 1 further comprising means for heating output gas from said vapor pressure chamber.

14. The vapor source generator of claim 1 wherein said vapor pressure chamber comprises inner surfaces that are inert to said carrier gas and said vapor source.
